(19) United States
(12) Patent Application Publication
(10) Pub. No.: US 2009/0041521 A1
(43) Pub. Date: Feb. 12, 2009

(54) Image forming apparatus

(75) Inventor: Fujio Tabata, Chuo-ku (JP)

Correspondence Address: JORDAN AND HAMBURG LLP, 122 EAST 42ND STREET, SUITE 4000, NEW YORK, NY, 10168, US

(73) Assignee: KYOCERA MITA CORPORATION, Chuo-ku (JP)

(21) Appl. No.: 12/228,401

(22) Filed: Aug. 11, 2008

(30) Foreign Application Priority Data
Aug. 10, 2007 (JP) 2007-210374

(51) Int. Cl. G03G 15/00

(52) U.S. Cl. 399/361

(57) ABSTRACT

An image forming apparatus capable of performing image formation without transfer deviations or rumples, including a loop amount sensor which includes a light emitting device irradiating a sheet material P passing between conveyance guide members with a light beam at a predetermined angle (θ) with respect to an optical base level, a light receiving device is provided with a light receiving surface receiving the reflected light beam of the light emitting device having been reflected from the sheet material P and a loop amount calculating portion calculating a loop amount of the sheet material by a triangulation method based on an arrival point Q3 of the reflected light beam received by the light receiving device on the light receiving surface, and the sensor detects the loop amount of the sheet material P based on a calculation result of the loop amount calculating portion

This application claims priority to Japanese Patent Application No. 2007-210374 filed Aug. 10, 2007. The contents of Japanese Patent Application No. 2007-210374 are hereby incorporated by reference into the present application in their entirety.

### BACKGROUND OF THE INVENTION

1. Technical Field

The present invention relates to an image forming apparatus that forms an image on a sheet material according to an electrophotographic method, and, more particularly, to an image forming apparatus capable of conveying a sheet material while keeping the loop of the sheet material between a transferring portion and a fixing portion at an appropriate amount.

2. Background Art

In an image forming apparatus using an electrophotographic method, a toner image on a photoconductor is first transferred to a sheet material by means of a transferring portion. Thereafter, the sheet material is allowed to pass through a conveying guide, and is guided to a nip of a fixing device. Herein, there is a case in which the trailing edge of the sheet material has not yet passed through the transferring portion when the leading edge of the sheet material enters the nip of the fixing device.

On the other hand, there is a case in which a difference arises between the sheet material conveying speed in the fixing device and the sheet material conveying speed in the transferring portion because of thermal expansion of a pressure roller provided in the fixing device, an individual difference, or a time-dependent change. In this case, if the sheet material conveying speed in the fixing device exceeds the sheet material conveying speed in the transferring portion, the sheet material carrying a not-yet-fixed toner image will be pulled toward the fixing device between the fixing device and the transferring portion, and, as a result, there is a fear that transfer deviation or slippage will occur.

To prevent the occurrence of this transfer deviation phenomenon, it has been conventionally performed to form a loop (i.e., a slackened state) for a sheet material conveyed between the transferring portion and the fixing device. However, there is a fear that the sheet material will be rumpled the next time if an excessive loop is given to the sheet material. Therefore, it is desired that the sheet material be conveyed while keeping its loop amount between the transferring portion and the fixing device at an appropriate amount.

A technique is known as an approach to respond to this request. This technique is carried out in the following way. In an image forming apparatus including a fixing unit and a transferring unit, drive systems are provided independently of each other for the fixing and transferring units, respectively. The upper limit and the lower limit of a loop amount formed by a sheet of paper at the front of an entrance of the fixing unit are detected. When its upper limit is detected, the speed of a driving portion provided on the side of the fixing unit is increased. When its lower limit is detected, the speed of the driving portion provided on the side of the fixing unit is decreased. Based on the loop amount detected in this way, the conveying speed of the sheet material is controlled. (See Japanese Published Unexamined Patent Application No. H7-234604).

However, in the conventional technique, the conveying speed of the sheet material is controlled based on the upper limit and the lower limit of the loop amount detected as above, and hence excellent results have not yet been achieved from the viewpoint of forming an image without transfer deviation or without rumples. In other words, to form an image without transfer deviation or rumples, there is a need to finely detect a loop amount and to reflect this in a control system for controlling the conveying speed. However, in the conventional technique, it is impossible to finely detect the loop amount at multiple stages including intermediate stages between the upper limit and the lower limit. Therefore, satisfactory results have not yet been achieved from the viewpoint of forming an image without transfer deviation or rumples.

### SUMMARY OF THE INVENTION

It is an object of the present invention to obtain an image forming apparatus capable of forming an image without transfer deviation or rumples.

In order to achieve the foregoing object, an image forming apparatus according to the present invention includes an image carrier by which a toner image is carried, a transferring portion configured to transfer the toner image of the image carrier on a sheet material, a fixing portion configured to fix the transferred toner image of the sheet material, a fixing and driving portion configured to send the sheet material fixed in the fixing portion, a conveyance guide member configured to guide the sheet material sent by the transferring portion toward the fixing portion, a loop amount detecting portion including a light emitting device irradiating the sheet material passing through the conveyance guide member with a reflected light beam at a predetermined angle with respect to an optical base level, a light receiving device provided with a light receiving surface receiving the reflected light beam of the light emitting device having been reflected from the sheet material and a loop amount calculating portion calculating a loop amount of the sheet material by a triangulation method based on an arrival point of the reflected light beam received by the light receiving device on the light receiving surface, the loop amount detecting portion detecting the loop amount of the sheet material passing through the conveyance guide member based on a calculation result of the loop amount calculating portion, and a drive controller carrying out drive control of the fixing and driving portion based on a detection result of the loop amount detecting portion.

In the image forming apparatus according to the present invention, the loop amount detecting portion that detects a loop amount of a sheet material passing through the conveyance guide member is provided with a loop amount calculating portion that calculates a loop amount of a sheet material at multiple stages including intermediate stages between the upper limit and the lower limit with high accuracy by a triangulation method based on an arrival point of the reflected light beam received by the light receiving device on the light receiving surface. On the basis of a calculation result of the loop amount at the multiple stages with high accuracy having been obtained by the loop amount calculating portion, the loop amount detecting portion detects the loop amount of the sheet material with a plurality of thresholds at multiple stages such as at least three stages. In response to that, in the drive controller, the loop amount at the multiple stages with high accuracy is fed back as a drive control element for the fixing and driving portion, through which the sheet material can be conveyed as the loop of the sheet material passing through the conveyance guide member is maintained at an appropriate amount. This contributes to image formation without transfer deviations or rumples.

### BRIEF DESCRIPTION OF THE DRAWINGS

FIG. 1 is a schematic diagram showing a main part of an image forming apparatus according to an embodiment of the present invention.

FIG. 2 is an external view from the side of a loop amount sensor according to the embodiment of the present invention.

### DETAILED DESCRIPTION OF THE INVENTION

An image forming apparatus according to an embodiment of the present invention will be hereinafter described in detail with reference to the attached drawings.

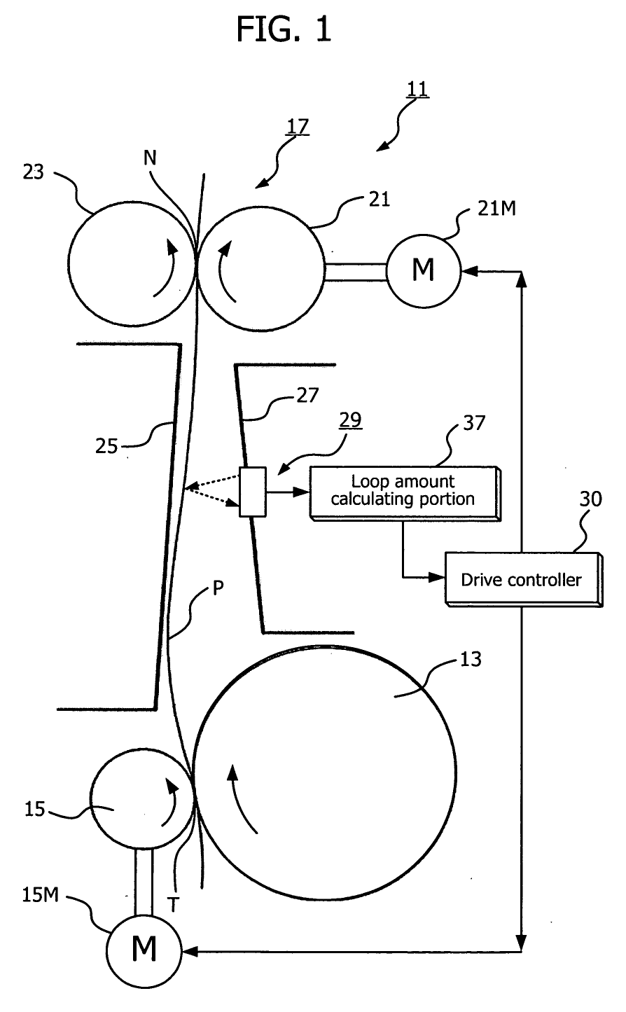

As shown in FIG. 1, an image forming portion 11 of the image forming apparatus according to the embodiment of the present invention serves to convey a sheet material P upwardly from below in the vertical direction. An electrophotoconductor 13 serving as an image carrier is disposed on the upstream side in a sheet material conveying direction. The photoconductor 13 has an organic photosensitive layer formed on an outer circumferential surface of an electrically-conductive photoconductor base, and is rotationally driven at a predetermined peripheral speed (process speed) in the clockwise direction as shown by the arrow in FIG. 1. The circumferential surface of the photoconductor 13 is charged by a charging device (not shown) during its rotation so as to have a predetermined polarity and a predetermined electric potential. In this embodiment, its circumferential surface is primarily charged so as to have a predetermined electric potential of a negative polarity. The charged surface of the photoconductor is subjected to laser scanning exposure of image information by use of a laser scanner (not shown). As a result, the electric potential of an exposure bright section of the charged surface of the photoconductor is attenuated, and an electrostatic latent image corresponding to a scanning exposure pattern is formed. Thereafter, this electrostatic latent image is developed as a developer image (hereinafter, referred to as “toner image”) by use of a developing device (not shown). In this embodiment, the electrostatic latent image is subjected to reversal development (i.e., adhesion of a toner to the exposure bright section) by means of a negative toner charged to have a negative polarity.

In a transfer nip portion T with which the photoconductor 13 and a transfer roller (transferring portion) 15 are brought into contact, the toner image is sequentially transferred onto a sheet material P fed from a paper feed mechanism (not shown). In a process in which the sheet material P is conveyed by running a transfer roller drive motor (transfer driving portion) 15M connected to the transfer roller 15 in a state in which the sheet material P is nipped in the transfer nip portion T, a predetermined transfer bias is applied to the transfer roller 15, and the toner image on the surface of the photoconductor 13 is electrostatically transferred to the surface of the sheet material P in sequence.

The sheet material sent from the transfer nip portion T is separated from the surface of the photoconductor 13, and is conveyed to a fixing device (fixing portion) 17. The surface of the photoconductor 13 from which the sheet material has been separated is cleaned by a cleaner (not shown) so as to remove any adhered matter, such as a transfer residual toner, and is used to repeatedly form an image.

The fixing device 17 is a heating device of, for example, a pressure rotational body driving type, and is made up of a fixing roller 21 and a pressure roller 23 connected to the fixing roller 21 via a gear mechanism (not shown). A fixing nip portion N is formed between the fixing roller 21 and the pressure roller 23. In the fixing nip portion N, a not-yet-fixed toner image conveyed from the transfer nip portion T is melted and fixed by being heated and pressed. The fixing roller 21 and the pressure roller 23 are members whose longitudinal direction is a direction perpendicular to the plane of the drawing paper in FIG. 1. While the sheet material P is passing through the fixing nip portion N and is being nipped in the fixing nip portion N, a fixing roller drive motor (fixing and driving portion) 21M connected to the fixing roller 21 is driven, so that the fixing roller 21 and the pressure roller 23 are synchronously rotated by means of the gear mechanism (refer to the arrow direction in FIG.1), and, as a result, the sheet material P is discharged and conveyed toward mechanisms disposed on the downstream side. Instead of the thus formed structure, the following structure maybe adopted. In detail, a pressure roller drive motor (not shown) is also connected to the pressure roller 23 without connecting the fixing roller 21 and the pressure roller 23 together via the gear mechanism, so that a fixing and driving portion is composed of the fixing roller drive motor 21M and the pressure roller drive motor. Through the cooperative operation of the fixing and driving portions, the sheet material P is discharged and conveyed toward mechanisms disposed on the downstream side while being nipped in the fixing nip portion N.

A pair of conveyance guide members 25 and 27 that guide the conveyance of sheet materials are disposed in a path leading from the transfer roller 15 to the fixing device 17 so as to face each other across a sheet material P therebetween. The conveyance guide member 27, which is one of the paired members, is provided with a loop amount sensor 29 that detects the loop amount of a sheet material. The loop amount sensor 29 is disposed approximately at the midpoint of a sheet material conveying path leading from the transfer nip portion T to the fixing nip portion N. The reason why the loop amount sensor 29 is disposed at that point is that, presumably, the loop amount of the sheet material leading from the transfer nip portion T to the fixing nip portion N is maximized near the midpoint.

Here, it is preferable to consider the following points when providing the loop amount sensor 29 on the conveying path of the sheet material. First, the loop amount sensor 29 is to be arranged in a position at a predetermined distance from the fixing device 17. This arrangement is because the influence of heat generated in the fixing device 17 on the loop amount sensor 29 can be obviated. In order to avoid the influence of the heat generated in the fixing device 17 as much as possible, a configuration to provide, for example, a cooling system such as fan to the loop amount sensor 29 may be adopted. Second, a configuration to provide, for example, an anti-paper-to-paper-friction rib in the installation site of the loop amount sensor 29 is to be adopted in order to eliminate the influence of paper dust. Third, to avoid the influence of electrification of sheets, a means for providing a lightning rod, optimizing a creepage distance, etc., may be employed. The loop amount sensor 29 serves to detect a loop amount of a sheet material at multiple stages with high accuracy.

A drive controller 30 is connected to the drive systems such as the transfer roller drive motor (transfer driving portion) 15M or the fixing roller drive motor (fixing and driving portion) 21M in order to control the rotary drive of these drive systems individually and independently. Based on the loop amount of the sheet material P detected by the loop amount sensor 29 at the multiple stages with high accuracy, the drive controller 30 controls the drive only of the fixing and driving portion or controls the drive of the transfer driving portion and the drive of the fixing and driving portion independently while linking them. By this means, the drive controller 30 serves to convey sheet materials with the loop of the sheet material P passing through the conveyance guide members 25 and 27 maintained at an appropriate amount. More specifically, the drive controller 30 controls the drive of the fixing and driving portion so as to slow its conveying speed, for example, when the loop amount sensor 29 detects an excessively small loop amount. On the other hand, the drive controller 30 controls the drive of the fixing and driving portion so as to increase its conveying speed when the loop amount sensor 29 detects an excessively large loop amount. Thus, the drive controller 30 operates so as to adjust the loop of the sheet material P at an appropriate amount. Instead of this configuration, another configuration may be adopted that the drive controller 30 controls the drive of the transfer driving portion and the drive of the fixing and driving portion independently while linking them such that the conveying speed of the fixing and driving portion becomes slower than that of the transfer driving portion, for example, when the loop amount sensor 29 detects an excessively small loop amount, whereas the drive controller 30 controls the drive of the transfer driving portion and the drive of the fixing and driving portion independently while linking them such that the conveying speed of the fixing and driving portion becomes faster than that of the transfer driving portion when the loop amount sensor 29 detects an excessively large loop amount, thereby operating to adjust the loop of the sheet material P at an appropriate amount.

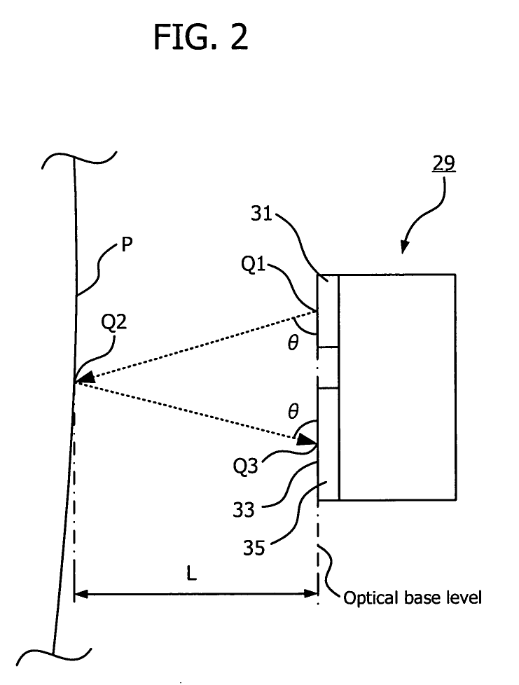

The loop amount sensor 29 serving as a loop amount detecting portion in the present invention, as shown in FIGS. 1 and 2, includes a light emitting device 31 irradiating the sheet material P passing between the conveyance guide members 25 and 27 with a reflected light beam at a predetermined angle (see the angle θ in FIG. 2, for example) with respect to an optical base level (see FIG. 2), a light receiving device 35 provided with a light receiving surface 33 that receives the reflected light beam of the light emitting device 31 having been reflected from the sheet material P and a loop amount calculating portion 37 calculating a loop amount of the sheet material P by a triangulation method based on a position coordinate of an arrival point of the reflected light beam received by the light receiving device 35 on the light receiving surface 33, and the loop amount sensor 29 has a function of detecting the loop amount of the sheet material P at multiple stages with high accuracy based on a calculation result of the loop amount calculating portion 37.

As the light emitting device 31, an infrared LED can be used, for example. An appropriate optical system may also be employed at a light beam outgoing port of the light emitting device 31.

As the light receiving device 35, a position sensor can be used, for example. An appropriate optical system may also be employed in the front of the light receiving surface 33 of the light receiving device 35.

In the example of FIG. 1, a loop amount sensor 29 including a light emitting device 31 and a light receiving device 35 is arranged at the conveyance guide member 27 side. In other words, the loop amount sensor 29 is arranged at a convex side of the loop of the sheet material P passing between the paired conveyance guide members 25 and 27. However, a configuration that the loop amount sensor 29 is provided at the conveyance guide member 25 side may be adopted.

The loop amount calculating portion 37 serves to calculate a loop amount of the sheet material P by a triangulation method based on a position coordinate of an arrival point of the reflected light beam received by the light receiving sensor 35 on the light receiving surface 33. In response to that, the loop amount sensor 29 detects the loop amount of the sheet material P at multiple stages with high accuracy, based on a calculation result of the loop amount calculating portion 37. The calculation result of the loop amount calculating portion 37 is supplied to the drive controller 30. Responding to that, in the drive controller 30, it is configured that the loop amount at the multiple stages with high accuracy is fed back as a drive control element for the fixing and driving portion, through which the sheet material P can be conveyed while the loop of the sheet material P passing between the conveyance guide members 25 and 27 is maintained at an appropriate amount.

As the loop amount sensor 29, more specifically, there can suitably be employed, for example, an integrated infrared distance measuring sensor that houses a light emitting device 31 composed of an infrared LED, a light receiving device 35 composed of a position sensor, an infrared LED drive circuit (not shown) and a position sensor signal processing circuit (not shown) therein and has a mode capable of obtaining analog voltage output according to a distance to an object only by connecting a power source to a power terminal and a ground terminal.

As shown in FIG. 2, for example, when a reflected light beam is irradiated by the light emitting device 31 toward the sheet material P passing between the conveyance guide members 25 and 27, at a predetermined angle (θ) with respect to the optical base level, the reflected light beam of the light emitting device 31 having been reflected from the sheet material P is received on the light receiving surface 33 of the light receiving device 35. Then, by joining each point of a position coordinate Q1 of an outgoing point of the light emitting device 31, a position coordinate Q2 of an arrival point of the light beam on the sheet material P and a position coordinate Q3 of an arrival point on the light receiving surface 33 of the light receiving device 35 by a line segment, an isosceles triangle with the vertex of the point Q2 and the bottom points of the points Q1 and Q3 is composed.

Here, the position coordinate (X, Y) of the outgoing point Q1 of the light emitting device 31 is already known. Therefore, as long as the position coordinate of the arrival point Q3 of the reflected light beam received by the light receiving device 35 on the light receiving surface 33 can be found, a distance L from the optical base level to the sheet material P can be obtained by a triangulation method.

Consequently, with the loop amount sensor 29 according to the embodiment of the present invention, a loop amount of the sheet material P at multiple stages including intermediate stages between the upper limit and the lower limit with high accuracy can be obtained by the triangulation method, based on the position coordinate Q3 of the arrival point of the reflected light beam received by the light receiving device 35 on the light receiving surface 33.

In response to that, in the drive controller 30, the loop amount at the multiple stages with high accuracy is fed back as a drive control element for the transfer roller drive motor (transfer driving portion) 15M and/or the fixing roller drive motor (fixing and driving portion) 21M, through which the sheet material P can be conveyed while the loop of the sheet material P passing through the conveyance guide members 25 and 27 is maintained at an appropriate amount. This contributes to image formation without transfer deviations or rumples.

As described above, the loop amount sensor 29 in the image forming apparatus according to the embodiment of the present invention includes a light emitting device 31 irradiating the sheet material P passing between the conveyance guide members 25 and 27 with a light beam at a predetermined angle (θ) with respect to the optical base level, a light receiving device 35 provided with a light receiving surface 33 receiving the reflected light beam of the light emitting device 31 having been reflected from the sheet material P and a loop amount calculating portion 37 calculating a loop amount of the sheet material P by a triangulation method, based on an arrival point Q3 of the reflected light beam received by the light receiving device 35 on the light receiving surface 33, and the loop amount sensor 29 detects the loop amount of the sheet material P based on a calculation result of the loop amount calculating portion 37. Accordingly, the loop amount at multiple stages including intermediate stages between the upper limit and the lower limit with high accuracy can be obtained by the triangulation method, based on the arrival point of the reflected light beam received by the light receiving device 35 on the light receiving surface 33. The thus obtained loop amount can be supplied to the drive controller 30. Consequently, in the drive controller 30, the loop amount of the sheet material P finely detected by the loop amount sensor 29 at the multiple stages is fed back as a controllability driving factor of the transfer roller drive motor (transfer driving portion) 15M and/or the fixing roller drive motor (fixing and driving portion) 21M, and, as a result, the sheet material P can be conveyed while keeping the loop of the sheet material P while passing between the conveyance guide members 25 and 27 at an appropriate amount, and hence a contribution can be made to the formation of an image without transfer deviation or rumples.

The present invention is not limited to the above-mentioned embodiment, and can be properly changed or modified within a range not departing from the spirit of the present invention or the technical idea thereof that can be read from the appended claims or the entire description. Such a modified image forming apparatus is also included in the technical scope of the present invention.

Specifically, although a description has been given of the image forming portion 11 formed to convey a sheet material P upwardly from below in the vertical direction as an embodiment of the present invention, the present invention is not limited to this. The present invention can be applied, without changes, to the image forming portion 11 formed to convey a sheet material P in any direction, such as a horizontal direction or a oblique direction.

Additionally, although a description has been given of the loop amount sensor 29 functioning as a loop amount detecting portion of the present invention that is disposed on the convex side of the loop in a sheet material P passing between the pair of conveyance guide members 25 and 27 as an embodiment of the present invention, the present invention is not limited to this. The loop amount sensor 29 may be disposed on the concave side of the loop in a sheet material P passing between the pair of conveyance guide members 25 and 27.

Lastly, a description has been given as exemplifying the electrophotoconductor serving as an image carrier. However, it should be understood that the present invention is not limited to the embodiment and may employ a transfer belt instead of the photoconductor.

1. An image forming apparatus, comprising:
an image carrier for carrying a toner image;
a transferring portion configured to transfer the toner image of the image carrier to a sheet material to obtain a transferred toner image;
a fixing portion configured to fix the transferred toner image on the sheet material;
a fixing and driving portion configured to send the sheet material with the transferred toner image to the fixing portion;
a conveyance guide member configured to guide the sheet material with the transferred toner image to fixing portion; and
a loop amount detecting portion, comprising:
a light emitting device configured for irradiating the sheet material passing by the conveyance guide member with a light beam, said light beam defining a predetermined angle with respect to an optical base level, said light beam reflecting from said sheet material to provide a reflected light beam; and
a light receiving device provided with a light receiving surface for receiving the reflected light beam ;
said image forming apparatus further comprising:
a loop amount calculating portion configured for calculating a loop amount of the sheet material by a triangulation method based on an arrival point of the reflected light beam received by the light receiving device on the light receiving surface; and
a drive controller configured for carrying out drive control of the fixing and driving portion based on a detection result of the loop amount detecting portion and a calculation by said loop amount calculating portion.

2. The image forming apparatus according to claim 1, wherein the light emitting device is an infrared LED.

3. The image forming apparatus according to claim 1, wherein the loop amount detecting portion is arranged at a predetermined distance from the fixing portion.

4. The image forming apparatus of claim 1, wherein the loop amount detecting portion is disposed approximately at a midpoint of a sheet material conveying path, said conveying path extending from the transferring portion to the fixing portion.

5. The image forming apparatus of claim 1, wherein the loop amount detecting portion is disposed at a convex side of a loop in the sheet material passing by the conveyance guide member.
